(19) United States
(12) Patent Application Publication
(10) Pub. No.: US 2011/0292901 A1
(43) Pub. Date: Dec. 1, 2011

(54) Method And Arrangement In A Wireless Communication System

(76) Inventors: Jonas Pettersson, Lulea (SE); Kristofer Sandlund, Lulea (SE)

(21) Appl. No.: 13/148,002

(22) PCT Filed: Feb. 9, 2009
(86) PCT No.: PCT/SE09/50130

§ 371 Date: Aug. 4, 2011

(51) Int. Cl. H04W 72/14

(52) U.S. Cl. 370/329; 370/328

(57) ABSTRACT

Method and arrangement in base station (110) for estimating the amount of data to be received from a terminal (120). The base station (110) and the terminal (120) are comprised within a wireless communication system (110). The terminal (120) comprises a buffer arranged to buffer frames comprising data. The method comprises determining (401) a service requested by the terminal (120), estimating (403) the arrival time of data to be received from the terminal (120), based on the determined service, and setting (404) a buffer estimate, comprising an estimation of the amount of data to be received, based on an estimated frame size for the determined service.

### TECHNICAL FIELD

The present invention relates to a method and arrangement in a wireless communication system and, more in particular, to a mechanism for improving buffer estimation.

### BACKGROUND

In the 3rd Generation Partnership Project (3GPP), work is ongoing on specifications of the UMTS Terrestrial Radio Access Network (UTRAN) evolution (E-UTRA) as part of the Long Term Evolution (LTE) effort.

In LTE, scheduling is modelled in the Medium Access Control (MAC) layer and resides in the eNodeB (eNB). The scheduler assigns radio resources, also called Resource Blocks (RB), for the downlink (assignments) as well as for the uplink (grants) using the Physical Downlink Control CHannel (PDCCH).

The radio uplink is the transmission path from a terminal, which may also by referred to as a User Equipment (UE), to a base station, or an eNodeB. A downlink is the inverse of an uplink, i.e. the transmission path from the eNodeB to the terminal.

For uplink scheduling, the eNodeB needs information about the current state of the buffers in the terminal, i.e. if and how much data the terminal has in its priority queues. This information is sent from the terminal to the eNodeB either as a 1-bit Scheduling Request (SR) or by a Buffer Status Report (BSR). The Scheduling Requests are transmitted on a control channel such as e.g. Physical Uplink Control CHannel (PUCCH) or Radio Access CHannel (RACH) while the BSR are transmitted on the data channel such as e.g. Physical Uplink Shared CHannel (PUSCH), mostly together with user data.

Precise and up-to-date scheduling information allows more accurate scheduling decisions, and can help to optimize the use and management of radio resources and to improve capacity. However, the accuracy of the information provided by the terminal is limited by the granularity of the buffer status reports, by the frequency of the Scheduling Request and buffer status report transmissions and by the delay between the reception of the Scheduling Request or buffer status report and the scheduling decision.

For delay sensitive services with periodical packet arrival, such as Voice over Internet Protocol (VoIP), the likelihood that the buffer status information is outdated when it is used is high. It is likely that additional data has arrived since the buffer status report was transmitted. It is also likely that the buffer will be emptied frequently and therefore the only available information will be a one bit Scheduling Request.

With incorrect uplink information, the scheduler will provide either a too large grant, which then results in the terminal transmitting padding and may reduce system capacity, or a too small grant, which may lead to Radio Link Control (RLC) segmentation and increase transmission delay.

Uplink buffer status reports are needed in order for the base station to know the amount of data waiting for transmission in the terminal. In E-UTRAN uplink buffer status reports refer to the data that is buffered for a Logical Channel Group (LCG) in the terminal. Four LCGs and two formats are used for reporting in uplink:

A short Buffer Status Report format, which contains the buffer size of one LCG and a long Buffer Status Report format, which contains the buffer sizes of all four LCGs.

Uplink buffer status reports are transmitted using MAC signalling.

According to the previously known solution in LTE, a framework for buffer status reporting is specified. Buffer status reporting is used by the terminal to report to the eNodeB the amount of data stored in its buffers for transmission. The eNodeB uses these reports to allocate resources to the terminal, and to prioritize resource allocation between different terminals.

The terminal triggers a regular Buffer Status Report and Scheduling Request when uplink data becomes available for transmission and if this data belongs to a radio bearer, i.e. logical channel, group with higher priority than those for which data already existed in the buffer or if the terminal buffers were empty just before this new data became available for transmission.

In case the transport block size is larger than the amount of data available for transmission at the time of assembly of the MAC Protocol Data Unit (PDU) for transmission, one Buffer Status Report can also be including, also referred to as a padding Buffer Status Report. In case the terminal has data for more than one logical channel but a Buffer Status Report format that can only contain information about one logical channel, a truncated format is also available as padding Buffer Status Report.

Another type of Buffer Status Report, the Periodic Buffer Status Report, provides a timer-based trigger per terminal to handle reporting for continuous flows.

FIG. 1 shows a simplified example of what might happen when a scheduling principle adopted for best-effort data services is applied to VoIP, resulting in unnecessary delay and many grant transmissions. The scheduling request triggers a small grant that only allows a Buffer Status Report and a small amount of data. While waiting for the grant, another packet arrives. So first two grants are spent to transmit one single packet and a packet that could have been transmitted with the second grant has to wait for another grant.

The current buffer status reporting framework has several shortcomings, such as e.g. the Buffer status information is likely to be outdated when used in scheduling decisions. Also, buffer status information is likely to be based on only a 1-bit Scheduling Request when used in scheduling decisions. Further, a solution to determine buffer status in a more efficient way would be most useful.

### SUMMARY

It is the object to obviate at least some of the above disadvantages and provide an improved performance within a communication system.

According to a first aspect, the object is achieved by a method in a base station. The method aims at estimating the amount of data to be received from a terminal. The base station and the terminal are comprised within a wireless communication system. The terminal comprises a buffer arranged to buffer frames comprising data. The method comprises determining a service requested by the terminal. Also, the method comprises estimating the arrival time of data to be received from the terminal, based on the determined service. Additionally, when data is estimated to have arrived the method further comprises setting a buffer estimate, comprising an estimation of the amount of data to be received, based on an estimated frame size for the determined service.

According to a second aspect, the object is also achieved by an arrangement in a base station. The arrangement aims at estimating the amount of data to be received from a terminal. The base station and the terminal are comprised within a wireless communication system. The arrangement comprises a buffer arranged to buffer frames comprising data. The arrangement comprises a determination unit. The determination unit is adapted to determine a service requested by the terminal. The arrangement also comprises an estimation unit. The estimation unit is adapted to estimate the arrival time of data to be received from the terminal, based on the frame interval of the determined service. Further, the arrangement also comprises a setting unit. The setting unit is adapted to set a buffer estimate, comprising an estimation of the size of the data to be received, based on an estimated frame size for the determined service.

By estimating the amount of data to be received from the terminal according to the present methods and arrangements, improved scheduling decisions can be taken by the base station which can reduce the packet delay and improve the radio resource utilization. Also, the total amount of signalling between the base station and the terminal may be reduced. As the number of grants that are transmitted within the system limits the number of terminals that may use the system simultaneously, it is possible to increase the load within the system by letting more terminals participate, as less grants has to be sent. Thereby an improved performance in a communication system is provided.

Other objects, advantages and novel features of the invention will become apparent from the following detailed description of the invention.

### BRIEF DESCRIPTION OF THE DRAWINGS

The present invention will now be described more in detail in relation to the enclosed drawings, in which:

FIG. 1 is a block diagram illustrating scheduling communication according to prior art.

FIG. 2 is a schematic block diagram illustrating a wireless communication system.

FIG. 3 is a flow chart illustrating scheduling communication according to some embodiments.

FIG. 4 is a flow chart illustrating embodiments of method steps in a radio base station.

FIG. 5 is a block diagram illustrating embodiments of an arrangement in a radio base station.

### DETAILED DESCRIPTION

The invention is defined as a method and an arrangement in a base station, which may be put into practice in the embodiments described below. This invention may, however, be embodied in many different forms and should not be constructed as limited to the embodiments set forth herein; rather, these embodiments are provided so that this disclosure will be thorough and complete, and will fully convey the scope of the invention to those skilled in the art. It should be understood that there is no intent to limit the present methods and/or arrangements to any of the particular forms disclosed, but on the contrary, the present methods and arrangements are to cover all modifications, equivalents, and alternatives falling within the scope of the invention as defined by the claims.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

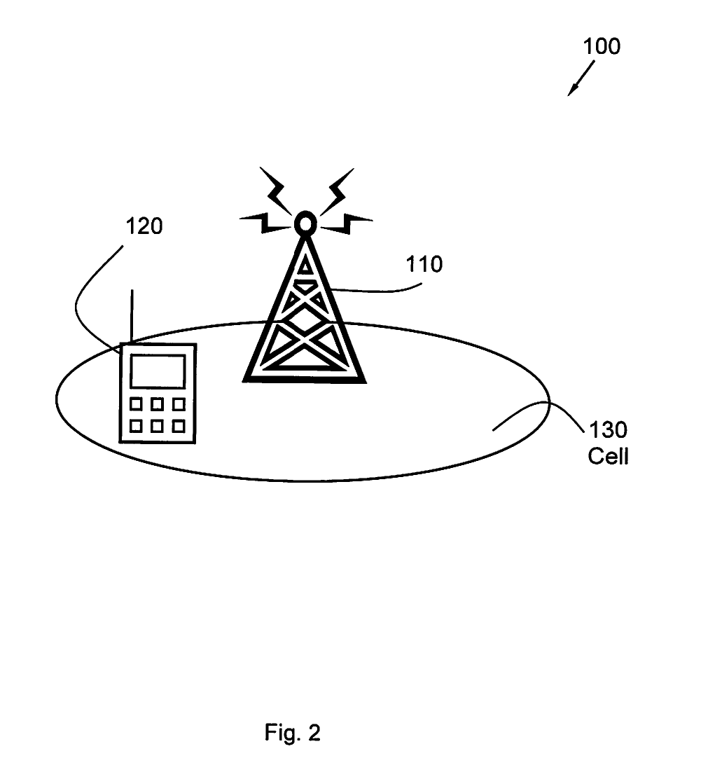

FIG. 2 is a schematic illustration over a wireless communication network 100. The wireless communication network 100 comprises at least one base station 110 and is arranged to comprise at least one terminal 120. The base station 110 may send and receive wireless signals to and from the terminal 120 situated within the cell 130.

Although only one base station 110 is shown in FIG. 2, it is to be understood that another configuration of base station transceivers may be connected through, for example, a mobile switching centre and other network nodes, to define the wireless communication network 100. Further, the base station 110 may be referred to as e.g. a Remote Radio Unit, an access point, a Node B, an evolved Node B (eNode B) and/or a base transceiver station, a Radio Base Station (RBS), Access Point Base Station, base station router, etc depending e.g. of the radio access technology and terminology used.

In some embodiments, the terminal 120 may be represented by a wireless communication device, a wireless communication terminal, a mobile cellular telephone, a Personal Communications Systems terminal, a Personal Digital Assistant (PDA), a laptop, a User Equipment (UE), computer or any other kind of device capable of managing radio resources.

The wireless communication network 100 may be based on technologies such as e.g. Long Time Evolution (LTE), Global System for Mobile Telecommunications (GSM), Enhanced Data rates for GSM Evolution (EDGE), General Packet Radio Service (GPRS), Code Division Multiple Access (CDMA), Wideband Code Division Multiple Access (WCDMA), CDMA 2000, High Speed Downlink Packet Data Access (HSDPA), High Speed Uplink Packet Data Access (HSUPA), High Data Rate (HDR) High Speed Packet Data Access (HSPA), Universal Mobile Telecommunications System (UMTS) etc, just to mention some few arbitrary and none limiting examples.

Further, as used herein, the wireless communication network 100 may further, according to some embodiments, refer to Wireless Local Area Networks (WLAN), such as Wireless Fidelity (WiFi) and Worldwide Interoperability for Microwave Access (WiMAX), Bluetooth or according to any other wireless communication technology.

It is to be noted however, that the present solution is not in any way limited to be performed exclusively over a radio interface within the wireless communication network 100, but may be performed within a wireless communication network 100 where some nodes are wirelessly connected and some nodes have a wired connection.

The wireless communication network 100 may, according to some particular, non limiting embodiments be adapted to provide a variety of services to a terminal 120 such as e.g. Voice Over IP (VoIP).

The wireless communication network 100 may according to some optional embodiments comprise a control node, depending e.g. on the access technology used. The control node may be e.g. a Radio Network Controller (RNC). The control node is a governing element in the wireless communication network 100, responsible for control of base stations 110, which are connected to the control node. The optional control node may further for example carry out radio resource management; some of the mobility management functions and may e.g. provide modulation information associated with information data to be sent from the base station 110 to the terminal 120, just to mention some brief examples illustrating some possible functionalities of the control node.

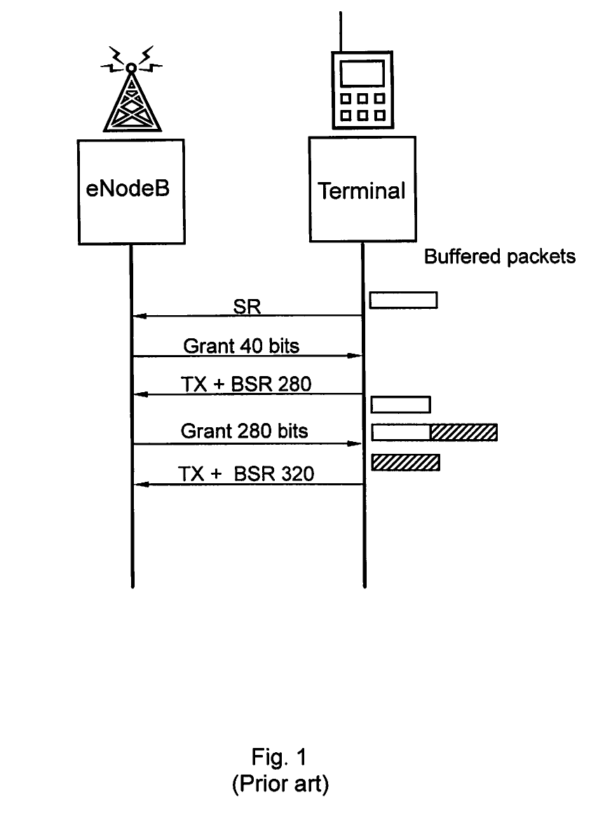

The terminal 120 may further communicate with other terminals not shown in FIG. 1, via the base station 110 comprised within the wireless communication network 100.

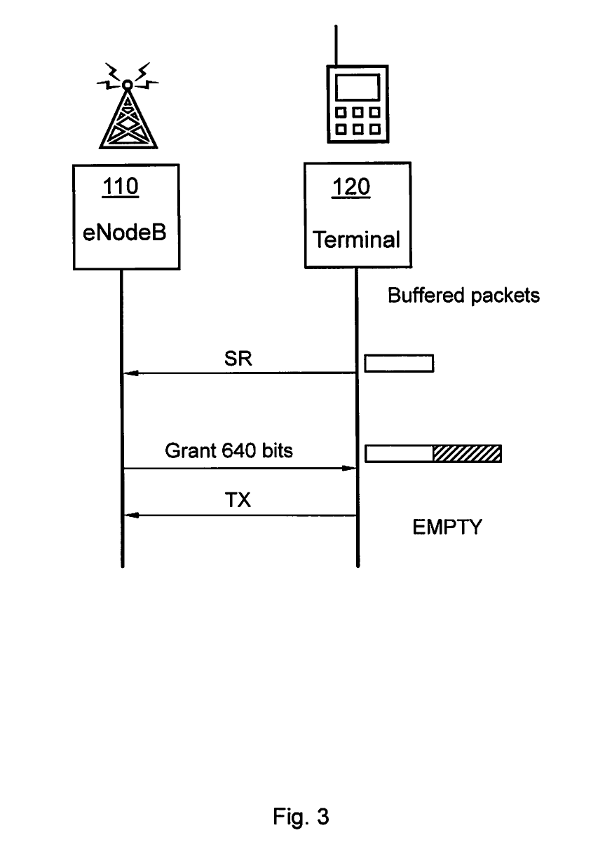

The base station 110 is further adapted to schedule the uplink transmissions from the terminals 120, to the base station 110. In order to grant a particular terminal 120 access to a particular uplink resource, a grant is sent from the base station 110 to that particular terminal 120, based on the estimated buffer status at the terminal 120, as will be further explained more in detail in connection with FIG. 3.

The expression “downlink” is here used to specify the transmission from the base station 110 to the terminal 120, while the expression “uplink” is used to denote the transmission from the terminal 120 to the base station 110.

FIG. 3 illustrates a mechanism for buffer status estimation, according to some embodiments. The base station 110 may establish a guess for when the first packet has arrived to the buffer of the terminal 120. The guess may be based on knowledge about the service behaviour to guess arrival times and packet sizes. Such knowledge may comprise e.g. that most VoIP codecs have a fixed frame interval of 20 ms when talking. Also, in silent state the frame interval may increase to e.g. 160 ms (AMR). Further it may be assumed e.g. that the packet size may be estimated to be the same as the previous packet. That may also be valid when Robust Header Compression (ROHC) is applied. Further yet, Codec state changes, such as a change from talk state to silence state may be detected by examining the sizes of received packets, according to some embodiments.

The present method aims at scheduling data efficiently, with an as short delay as possible. As seen in the illustrative, however non-limiting example illustrated in FIG. 3, a 320 bit data packet is buffered in the terminal 120. A Status Report (SR) may be sent from the terminal 120 to the base station 110. The base station 110 estimates that a further 320 bit data packet may arrive to the terminal 120 before a grant sent from the base station 110 has propagated to the terminal 120. Thus a 640 bits grant may be sent from the base station 110 to the terminal 120. Having received that grant, the terminal 120 may send the two data packets comprising 640 bits to the base station 110.

The terminal buffer estimation at the base station 110 may be performed by applying an algorithm intended to increase the VoIP capacity by exploiting the knowledge that a talk frame will be ready for transmission in a previously known time period, such as e.g. every 20 ms, when the user is talking. By using this knowledge, the buffer estimator may preemptively add buffer estimates to terminals 120 in order to grant the terminal 120 without having to receive neither an SR nor a BSR. Thus proactive grants may be sent from the base station 110 to the terminal 120, thereby reducing the overall traffic load within the system 100. It also allows for more accurate estimation of the buffer status in a highly loaded system 100 where the interval between a terminal 120 being scheduled might be higher than 20 ms and therefore multiple frames may be comprised in a single grant.

The algorithm further may distinguish and alter between at least two states, SID and TALK. A state change may occur when the codec switches between the corresponding states, talk state and silence state. The TALK state may be considered as a proactive buffer estimation state which guesses when the next talk frame will arrive and which size it will have, while the SID state may be considered as a passive state that expects SRs when data has arrived for a terminal 120.

In TALK state

On scheduling request reception: If the current buffer estimate is zero, the buffer size may be set to the expected size of one talk frame and the estimated arrival time may be set to the request transmission time. If the current buffer estimate for this terminal 120 is non-zero, nothing is done, according to some embodiments.

A talk frame interval after latest estimated arrival: the buffer size estimate may be increased by the size of the last received frame and set the latest estimated arrival time to current time.

On BSR Reception, the buffer size estimates may be updated according to the report.

On reception of an RLC SDU: If the size of the SDU is smaller than the talk threshold, which may be between the size of a SID frame and the size of a talk frame, the SID state may be entered.

Thus according to some embodiments:

SID frame size<talk threshold<talk frame size

On reception of a transport block: If two consecutive transmissions are received with only padding, the SID state may be entered according to some embodiments.

In SID state

On scheduling request reception: If the current buffer estimate is zero, the buffer size may be set to the expected size of one SID frame and the estimated arrival time may be set to the request transmission time. If the current buffer estimate for this user is non-zero, nothing may be done, according to some embodiments.

On BSR Reception: the Buffer size estimates may be updated according to the report. If the remaining size indicated in the VoIP queue is larger than the SID threshold, which may be similar to the size of a SID frame, the TALK state may be entered.

On reception of an RLC SDU: If the size of the SDU is larger than the talk threshold, which should be between the size of a SID frame and the size of a talk frame, the TALK state may be entered.

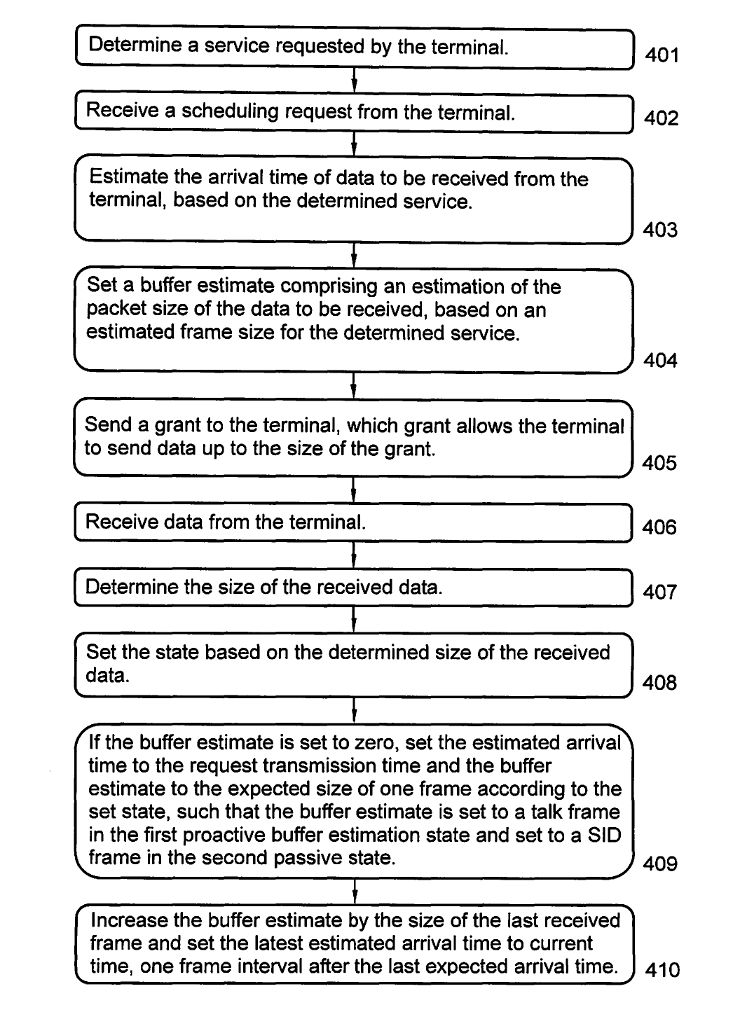

FIG. 4 is a flow chart illustrating embodiments of method steps 401-410 performed in a base station 110. The method aims at estimating the amount of data to be received from a terminal 120. The base station 110 and the terminal 120 are comprised within a wireless communication system 100. The terminal 120 comprises a buffer arranged to buffer frames comprising data. The method may be performed in any of a first proactive buffer estimation state or a second passive state. The first proactive buffer estimation state may corresponds to the talk codec state. The second passive state corresponds to the silence codec state.

To appropriately estimate the amount of data to be received from the terminal 120, the method may comprise a number of method steps 401-410.

It is however to be noted that some of the method steps 401-410 are optional and may only be performed within some embodiments. Further, the method steps 401-410 may be performed in any arbitrary chronological order and some of them, e.g. step 406 and step 407, or even all steps 401-410 may be performed simultaneously or in an altered, arbitrarily rearranged, decomposed or even completely reversed chronological order, according to different embodiments. The method may comprise the following steps:

### Step 401

It is determined which service the terminal 120 requests. The service may be e.g. VoIP, just to mention an example.

### Step 402

This step is optional and may only be performed within some embodiments.

A scheduling request is received from the terminal 120.

### Step 403

The arrival time of data to be received from the terminal 120 is estimated, based on the determined service. According to some embodiments, the arrival time estimation may be based on the frame interval of the determined service.

The estimation of the arrival time of data may optionally be based on the received scheduling request.

### Step 404

When data is estimated to have arrived, a buffer estimate, comprising an estimation of the amount of data to be received is set, based on an estimated frame size for the determined service.

The buffer estimate may optionally be updated according to a buffer status report received from the terminal 120.

### Step 405

This step is optional and may only be performed within some embodiments.

A grant may be sent to the terminal 120. The grant allows the terminal 120 to send data up to the size of the grant.

### Step 406

This step is optional and may only be performed within some embodiments.

Data may be received from the terminal 120.

If a Service Data Unit (SDU) is received from the terminal 120 which is smaller than a threshold limit value, the method state may be set into the passive state, otherwise the method state may be set into the proactive buffer estimation state.

The threshold limit value may optionally be set to a value equal to, or larger than the size of a Silence Insertion Descriptor (SID) frame and smaller than, or equal to the size of a talk frame.

If two consecutive frames comprising only padding are received from the terminal 120, the method state may be set into the passive state.

### Step 407

This step is optional and may only be performed within some embodiments.

The size of the received data may be determined.

### Step 408

This step is optional and may only be performed within some embodiments.

The state may be set, based on the determined size of the received data. The state may be any of a first proactive buffer estimation state, or a second passive state.

### Step 409

This step is optional and may only be performed within some embodiments.

If the buffer estimate is set to zero, the estimated arrival time may be set to the transmission time of the scheduling request and the buffer estimate to the expected size of one state specific frame size according to the set state.

### Step 410

This step is optional and may only be performed within some embodiments.

If the method is performed in the first proactive buffer estimation state, the buffer estimate may be increased by the size of the estimated frame size and set the latest estimated arrival time to current time, one frame interval after the last expected arrival time. The estimated frame size may be the size of the last received frame.

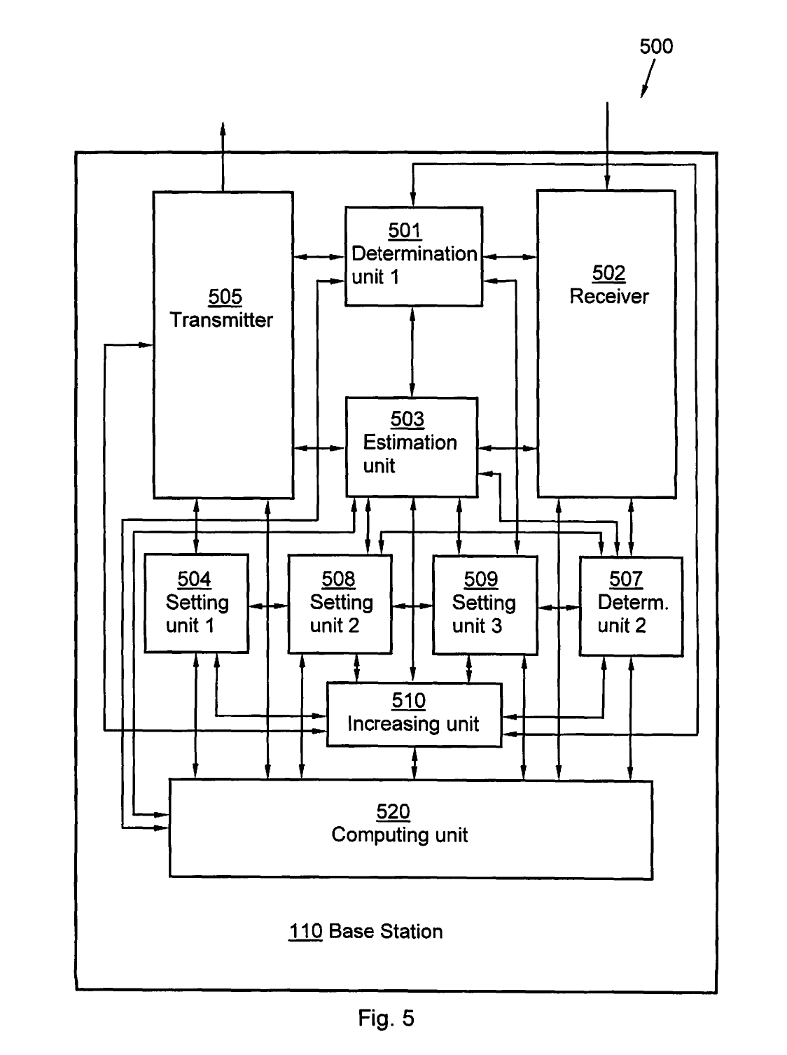

FIG. 5 is a block diagram illustrating embodiments of an arrangement 500 situated in a base station 110. The arrangement 500 is configured to perform the method steps 401-410 for estimating the amount of data to be received from a terminal 120. The base station 110 and the terminal 120 are comprised within a wireless communication system 100. The terminal 120 comprises a buffer arranged to buffer frames comprising data.

For the sake of clarity, any internal electronics of the arrangement 500, not completely necessary for performing the present method has been omitted from FIG. 5.

The arrangement 500 comprises a first determination unit 501. The first determination unit 501 is adapted to determine a service requested by the terminal 120. Further, the arrangement 500 comprises an estimation unit 503. The estimation unit 503 is adapted to estimate the arrival time of data to be received from the terminal 120, based on the frame interval of the determined service. Also, the arrangement 500 comprises a first setting unit 504. The first setting unit 504 is adapted to set a buffer estimate, comprising an estimation of the size of the data to be received, based on an estimated frame size for the determined service.

The arrangement 500 may further comprise a receiving unit 502. The receiving unit 502 may be adapted to receive a scheduling request and/or data and/or Buffer Status Reports from the terminal 120. In addition, the arrangement 500 may comprise a sending unit 505. The sending unit 505 may be adapted to send a grant to the terminal 120. Further, the arrangement 500 may additionally comprise a second determination unit 507. The second determination unit 507 may be adapted to determine the size of the received data. Also, the arrangement 500 may optionally comprise a second setting unit 508. The second setting unit 508 may be adapted to set the state based on the determined size of the received data. In further addition, the arrangement 500 may also comprise a third setting unit 509. The third setting unit 509 may be adapted to set the estimated arrival time to the transmission time of the scheduling request and the buffer estimate to the expected size of one state specific frame size according to the set state. Additionally, the arrangement 500 may further comprise an incrementing unit 510. The incrementing unit 510 may be adapted to increase the buffer estimate by the size of the estimated frame size and set the latest estimated arrival time to current time, one frame interval after the last expected arrival time.

The arrangement 500 may according to some embodiments further comprise a processor unit 520. The processor unit 520 may be represented by e.g. a Central Processing Unit (CPU), a processor, a microprocessor, or other processing logic that may interpret and execute instructions. The processor unit 520 may perform all data processing functions for inputting, outputting, and processing of data including data buffering and device control functions, such as call processing control, user interface control, or the like.

It is to be noted that the described units 501-520 comprised within the arrangement 500 may be regarded as separate logical entities, but not with necessity as separate physical entities. Any, some or all of the units 501-520 may be comprised or co-arranged within the same physical unit. However, in order to facilitate the understanding of the functionality of the arrangement 500, the comprised units 501-520 are illustrated as separate units in FIG. 5.

Thus the transmitting unit 505 and e.g. the receiving unit 502 may, according to some embodiments, be comprised within one physical unit, a transceiver, which may comprise a transmitter circuit and a receiver circuit, which respectively transmits outgoing radio frequency signals to the terminal 120 and receives incoming radio frequency signals from the terminal 120 via an optional antenna. The radio frequency signals transmitted between the base station 110 and the terminal 120 may comprise both traffic and control signals e.g., paging signals/messages for incoming calls, which may be used to establish and maintain a voice call communication with another party or to transmit and/or receive data, such as SMS, e-mail or MMS messages, etc.

### Computer Program Product in the Base Station 110

The method steps 401-410 in the base station 110 may be implemented through one or more processor units 520 in the base station 110, together with computer program code for performing the functions of the present method steps 401-410. Thus a computer program product, comprising instructions for performing the method steps 401-410 in the base station 110 may estimate the amount of data to be received from the terminal 120.

The computer program product mentioned above may be provided for instance in the form of a data carrier carrying computer program code for performing the method steps according to the present solution when being loaded into the processor unit 520. The data carrier may be e.g. a hard disk, a CD ROM disc, a memory stick, an optical storage device, a magnetic storage device or any other appropriate medium such as a disk or tape that can hold machine readable data. The computer program code can furthermore be provided as pure program code on a server and downloaded to the base station 110 remotely, e.g. over an Internet or an intranet connection.

Further, a computer program product comprising instructions for performing at least some of the method steps 401-410 may be used for implementing the previously described method in the base station 110, when the computer program product is run on a processing unit 520 comprised within the base station 110.

The present invention may be embodied as a method and an arrangement in a radio base station 110, and/ or computer program products. Accordingly, the present invention may take the form of an entirely hardware embodiment, a software embodiment or an embodiment combining software and hardware aspects all generally referred to herein as a “circuit”. Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

The terminology used in the detailed description of the particular exemplary embodiments illustrated in the accompanying drawings is not intended to be limiting of the invention.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

1. Method in a base station for estimating an amount of data to be received from a terminal, wherein the base station and the terminal are within a wireless communication system, wherein the terminal comprises a buffer arranged to buffer frames comprising data, the method comprising:
determining a service requested by the terminal,
estimating an arrival time of data to be received from the terminal, based on the determined service, and
when data is estimated to have arrived, setting a buffer estimate, comprising an estimation of the amount of data to be received, based on an estimated frame size for the determined service.

2. Method according to claim 1, wherein estimating the arrival time of data comprises basing the estimation on the frame interval of the determined service.

3. Method according to claim 1, further comprising:
receiving a scheduling request from the terminal, and;
wherein estimating the arrival time of data comprises basing the estimation of the arrival time of data on the received scheduling request.

4. Method according to claim 1, further comprising:
sending a grant to the terminal, which grant allows the terminal to send data up to the size of the grant.

5. Method according to claim 1, wherein the method is performed in any of a first proactive buffer estimation state or a second passive state, and wherein the method further comprises:
receiving data from the terminal,
determining the size of the received data, and
setting the state based on the determined size of the received data.

6. Method according to claim 1, further comprising:
if the buffer estimate is set to zero, setting the estimated arrival time to the transmission time of the scheduling request and the buffer estimate to the expected size of one state specific frame size according to the set state.

7. Method according to claim 1, further comprising:
if the base station is in a first proactive buffer estimation state, increasing the buffer estimate by the size of a last received frame and setting a latest estimated arrival time to current time, one frame interval after a last expected arrival time.

8. Method according to claim 7, wherein, if a Service Data Unit “SDU” is received from the terminal which is smaller than a threshold limit value, the base station is set into a passive state, otherwise the base station is set into the proactive buffer estimation state.

9. Method according to claim 8, wherein the threshold limit value is set to a value equal to, or larger than a size of a Silence Insertion Descriptor “SID” frame and smaller than, or equal to a size of a talk frame.

10. Method according to claim 9, wherein, if two consecutive frames comprising only padding are received from the terminal, the base station is set into the passive state.

11. Arrangement in a base station for estimating an amount of data to be received from a terminal, wherein the base station and the terminal are within a wireless communication system, wherein the terminal comprises a buffer arranged to buffer frames comprising data, the arrangement comprising:
a determination unit, adapted to determine a service requested by the terminal,
an estimation unit, adapted to estimate an arrival time of data to be received from the terminal, based on the frame interval of the determined service, and
a setting unit, adapted to set a buffer estimate, comprising an estimation of the amount of the data to be received, based on an estimated frame size for the determined service.
